(19) United States
(12) Patent Application Publication
(10) Pub. No.: US 2016/0113734 A1
(43) Pub. Date: Apr. 28, 2016

(54) BLASTING DEVICE

(71) Applicant: Renfert GmbH, Hilzingen (DE)

(72) Inventor: Sven GOLDHAGEN, Radolfzell (DE)

(21) Appl. No.: 14/923,789

(22) Filed: Oct. 27, 2015

(30) Foreign Application Priority Data
Oct. 28, 2014 (DE) 10 2014 115 675.7

(51) Int. Cl. A61C 3/025; A61C 1/00

(52) U.S. Cl. CPC A61C 3/025; A61C 1/0061

(57) ABSTRACT

A blasting device, in particular a dental blasting device, includes at least one blasting chamber, and at least one housing, which is made at least partially of plastic and has at least one base body at least partially encompassing the blasting chamber.

The housing is produced at least partially in an injection molding method.

### PRIOR ART

The invention relates to a blasting device, in particular a dental blasting device, with at least one blasting chamber, and with at least one housing, which has at least one base body at least partially encompassing the blasting chamber.

The object of the invention is in particular to make available a device of the type in question which has improved properties in terms of weight, in terms of variability, and in terms of the production and assembly outlay. The object is achieved, according to the invention, by the features of claim 1, while advantageous embodiments and developments of the invention are set forth in the dependent claims.

### Advantages of the Invention

The invention relates to a blasting device, in particular a dental blasting device, with at least one blasting chamber, and with at least one housing, which is made at least partially of plastic and has at least one base body at least partially encompassing the blasting chamber.

It is proposed that the housing is produced at least partially in an injection molding method. There are various plastics that a person skilled in the art would deem suitable for use. Preferably, the housing is made at least partially of an amorphous plastic. Preferably, the housing is made at least partially of an ABS plastic, i.e. of acrylonitrile butadiene styrene. Particularly preferably, the base body is in particular made entirely of plastic. Preferably, the housing is made at least almost entirely of plastic. Preferably, the housing is produced completely in an injection molding method. Preferably, the housing is produced in a thermoplastic injection molding method. Particularly preferably, the housing is produced in a compact injection molding method. In this context, a “blasting device” is to be understood in particular as an appliance provided to spray abrasive material into a blasting chamber. The abrasive material is preferably sprayed via a handpiece. Particularly preferably, it is understood in particular to mean an appliance provided to treat the surface of products, in particular of dental products, by means of a mixture of air and abrasive material. An “abrasive material” is to be understood in particular as a material which is powdery and/or finely particulate and which is provided to remove and/or compact a surface of a product, in particular of a dental product. Moreover, a “handpiece” is to be understood in particular as a unit that is held at least partially by an operator during operation. Preferably, it is to be understood in particular as a unit with at least one nozzle through which abrasive material, in particular a mixture of air and abrasive material, is sprayed at least partially during an operation. Moreover, in this context, a “blasting chamber” is to be understood in particular as a chamber in which the abrasive material emerges in at least one operating state. Preferably, it is to be understood in particular as a chamber which, in at least one state, is closed off at least substantially. Particularly preferably, it is to be understood in particular as an operating chamber which defines a work area of an operator and which is provided to prevent abrasive material from flying around in an uncontrolled manner. Furthermore, in this context, a “housing” is to be understood in particular as a structural part of the blasting device that at least partially engages around and/or defines the blasting chamber. Preferably, it is to be understood in particular as a structural part which at least partially defines an outer contour of the blasting device. Preferably, it is to be understood in particular as a structural part which at least partially forms a base structure of the blasting device. Particularly preferably, it is to be understood in particular as a structural part which interconnects at least some of the structural parts of the blasting device that are distinct from the housing. In this context, a “base body” of the housing is to be understood in particular as a part of the housing which in particular forms an at least substantial proportion, i.e. in particular at least 20%, preferably at least 30%, and particularly preferably at least 50%, of a volume of the housing. Preferably, it is to be understood in particular as a part of the housing that at least partially engages around and/or defines the blasting chamber. Particularly preferably, it is to be understood in particular as a part of the housing which at least partially interconnects areas of the housing that are distinct from the base body. In this context, “the housing is made at least partially of plastic” is to be understood in particular as meaning that at least 40%, preferably at least 60%, and particularly preferably at least 80%, of a material volume is made from a plastic. “Provided” is to be understood in particular as meaning specially designed and/or equipped. The fact that an object is provided for a defined function is to be understood in particular as meaning that the object fulfills and/or executes this defined function in at least one use state and/or operating state.

With an embodiment of the blasting device according to the invention, it is possible in particular to make available a blasting device which is advantageously light and yet at the same time robust. Preferably, the housing can thus be produced in an advantageously cost-effective manner. Moreover, the work involved in production and assembly of the blasting device can be kept to a minimum. Furthermore, it is thereby advantageously possible to achieve a high degree of variability of the blasting device, in particular of the housing. Moreover, an advantageously high level of functionality of the blasting device, in particular of the housing, can be achieved. In particular, in an injection molding method, structural parts can advantageously be injected directly onto the housing. In this way, assembly work can advantageously be kept to a minimum.

It is moreover proposed that the blasting device has at least one front apron, which is fixedly connected to the housing and is provided to cover at least a partial area of the housing. The front apron is preferably provided to cover at least a partial area of the base body from outside. Preferably, the front apron is made at least partially of plastic. Preferably, the front apron is made at least partially of an amorphous plastic. Particularly preferably, the front apron is made at least partially of ABS plastic. In this context, a “front apron” is to be understood in particular as a screen arranged at the front and in particular directed toward an operator. Preferably, it is to be understood in particular as a screen which, in an assembled state, covers at least a front partial area of the housing, in particular a partial area directed toward an operator. Preferably, it is to be understood in particular as a screen which is at least partially separate from the housing. Particularly preferably, it is to be understood in particular as a screen which is at least partially spaced apart from the housing. In this way, a double wall can be obtained particularly in a partial area of the blasting device directed toward an operator. In this way, an operator can advantageously be afforded additional protection. Moreover, soundproofing can advantageously be achieved in this way. A high degree of stability of the housing can preferably be achieved.

Furthermore, it is proposed that the at least one front apron has at least one latching element, which latches with at least one corresponding latching element of the housing. Preferably, the front apron is connected to the housing with a latching action. In this context, a “latching element” is to be understood in particular as a resilient element which produces a latching connection and which is provided to be deflected elastically during assembly. Preferably, it is to be understood in particular as an element that is deflected elastically during a fastening procedure, in order thereafter to latch behind a corresponding latching element by way of an internal clamping force. In this way, a connection between the front apron and the housing can be made available which, in particular, is advantageously easy to produce and to release. Moreover, an advantageously reliable connection can in particular be made available between the front apron and the housing.

It is further proposed that the at least one housing has at least one ventilation opening, which is distinct from a hand port and which, in an assembled state of the front apron, is covered at least substantially by the front apron. In this context, a “hand port” is to be understood in particular as an opening in the housing through which a hand of an operator is guided into the blasting chamber during normal operation. Preferably, the housing has two hand ports, through each one of which a hand of the operator can be guided. Moreover, in this context, a “ventilation opening” is to be understood in particular as an opening which is distinct from a hand port and which is introduced into the housing in the direction toward the blasting chamber. Preferably, it is to be understood in particular as an opening through which air can flow into the blasting chamber in a controlled manner. Particularly preferably, air can enter the blasting chamber through the ventilation opening so as to avoid an underpressure despite a suction in the blasting chamber. Moreover, it is thus possible to prevent air from being sucked in through the hand ports. In this context, the fact that “the ventilation opening is covered at least substantially by the front apron” is to be understood in particular as meaning that, in a frontal view of the blasting device, in an imagined image plane, at least 50%, preferably at least 70%, and particularly preferably at least 90%, of a surface area of the ventilation opening is covered by the front apron. Furthermore, in this context, “covered” is to be understood in particular as meaning that, in a work position, the front apron is located between the ventilation opening and an operator. Preferably, it is to be understood in particular as meaning that a view of the ventilation opening from the outside is obstructed by the front apron. In this way, the noise of air being sucked in through the ventilation opening can be advantageously damped, for an operator, by the front apron. In addition, a noise emanating from the blasting chamber through the ventilation opening can be damped, for an operator, by the front apron. Moreover, an operator can be protected from parts flung from the ventilation opening.

It would also be conceivable for the ventilation opening to have a variable opening size. It would preferably be conceivable in this case that the ventilation opening can be throttled. The ventilation opening could be throttled, for example, by a movable diaphragm and/or mask.

It is further proposed that the at least one housing has at least one jib unit, which is formed integrally with the base body of the housing and which is provided as a bottom receptacle of at least one blasting material tank unit. Preferably, the jib unit additionally serves to protect against tilting. Particularly preferably, the jib unit is injected onto the base body of the housing. In this context, a “jib unit” is to be understood in particular as a part of the housing which protrudes, particularly like a stage, from the base body of the housing. Preferably, the jib unit is provided to at least partially form a bearing surface for the blasting material tank unit. Furthermore, “integrally” is to be understood in particular as meaning connected at least by cohesive bonding, for example by a welding process, an adhesive bonding process, an injection process and/or another process deemed appropriate by a person skilled in the art, and/or as meaning advantageously formed in one piece, for example by production from a cast and/or by production in a single-component or multi-component injection molding method and advantageously from a single blank. Moreover, in this context, a “blasting material tank unit” is to be understood in particular as a unit with at least one tank container for holding an abrasive material. Preferably, it is to be understood in particular as a unit with at least one tank container and with at least one mixing unit connected to the tank container. Here, a “mixing unit” is to be understood in particular as a unit which, in at least one operating state, is provided to mix compressed air with the abrasive material in order to make available a mixture of air and abrasive material, which mixture is provided to treat products, in particular dental products. In this context, the fact that “the jib unit is injected onto the base body” is to be understood in particular as meaning that the jib unit is formed onto the base body in an injection method or is formed with the base body in an injection molding method. The jib unit can be injected onto the base body in a separate work step or can also be formed together with the base body in an injection molding method. In this way, the number of structural parts of the blasting device can in particular be kept to a minimum. Moreover, a reliable fastening of a blasting material tank unit can be permitted in particular. Particularly preferably, the assembly outlay of the blasting device can in particular be kept to a minimum in this way. In particular, a high-density functionality of the housing can be achieved.

Moreover, the at least one jib unit of the housing has at least one recess, which is provided to laterally secure the at least one blasting material tank unit. Preferably, the at least one recess is provided to receive and laterally secure at least one extension piece of the at least one blasting material tank unit. Particularly preferably, the recess is provided to secure the at least one blasting material tank unit in a plane, in particular in a horizontal plane. Reliable securing of the at least one blasting material tank unit can be achieved in this way.

It is further proposed that the at least one housing has at least one further jib unit, which is formed integrally with the base body of the housing and which is provided to receive at least one adjustment unit for adjusting a pressure of the at least one blasting material tank unit. Preferably, a pressure in the at least one blasting material tank unit can be adjusted via the adjustment unit. Preferably, the adjustment unit is designed as a pressure reducer. Particularly preferably, the further jib unit is injected onto the base body of the housing. In this way, the number of structural parts of the blasting device can in particular be kept to a minimum. Moreover, reliable fastening of an adjustment unit can in particular be permitted. Particularly preferably, the assembly outlay of the blasting device can in particular be kept to a minimum in this way. In particular, a high-density functionality of the housing can be achieved.

It is further proposed that the at least one housing has at least one suction opening formed at least partially integrally with the base body of the housing. Particularly preferably, the suction opening has at least one guide tube, which is injected onto the base body of the housing. In this context, a “suction opening” is to be understood as an opening through which air and/or abrasive material can be sucked out of the blasting chamber. Preferably, it is to be understood in particular as an opening through which excess or already used abrasive material can be sucked out of the blasting chamber. Preferably, it is to be understood in particular as an opening which protrudes into the blasting chamber and, during an operation, is preferably attached to a suction piece. It is thereby possible to advantageously reduce, at least partially, the swirling of abrasive material in the blasting chamber. Moreover, a high-density functionality of the housing can be achieved.

It is additionally proposed that the at least one housing has at least one hose retainer, which is formed integrally with the base body of the housing and which is provided to guide a hose of a handpiece on an underside of the housing. Preferably, the hose retainer is provided such that a hose extending between a blasting material tank unit and the handpiece is guided on an underside of the housing. Preferably, the hose retainer is provided to clamp a hose releasably. Particularly preferably, the hose retainer is injected onto the base body of the housing. In this context, a “hose retainer” is to be understood in particular as an element which is provided to position a hose in a partial section along the main extent of the hose. Preferably, it is to be understood in particular as an element which is provided to retain a hose in a partial section along the main extent of the hose. Particularly preferably, the hose retainer at least partially engages around the hose for this purpose. In this way, the number of structural parts of the blasting device can in particular be kept to a minimum. Moreover, reliable guiding of the hose on the housing can in particular be permitted. Preferably, the assembly outlay of the blasting device can in particular be kept to a minimum in this way.

It is further proposed that the blasting device has at least one cuff unit with at least one cuff and with at least one fastening ring, by means of which the cuff unit is connected releasably, in the manner of a bayonet catch, to the at least one housing. In this context, a “cuff unit” is to be understood in particular as a unit which is preferably arranged in a hand port of the housing and which, during an operation, is provided to prevent abrasive material from escaping from the blasting chamber via the hand port. Preferably, it is to be understood in particular as a unit which, during an operation, is provided to at least partially close a gap between the housing and a hand or an arm of the operator in a variable manner. Moreover, in this context, a “cuff” is to be understood in particular as a movable, tubular element which, with one end, is provided to enclose a hand or an arm of the operator and which, with another end, is provided to bear all the way round on a hand port of the housing. Preferably, it is to be understood in particular as an element which, with one end, is provided to enclose a hand or an arm of the operator in the manner of a sleeve and which widens in a funnel shape toward another end in order to bear on a hand port of the housing. Preferably, the cuff is made of a movable, elastic material, for example a textile material. In this context, the fact that “the cuff unit is connected releasably, in the manner of a bayonet catch, to the at least one housing by means of the at least one fastening ring” is to be understood in particular as meaning that the fastening ring is connected releasably to the housing with a form fit and/or force fit and at the same time fixes the cuff on the housing. Preferably, the connection can be made and/or released at least partially by means of a combined movement composed of a plug-in movement and a rotation movement. In this way, the at least one cuff unit can be assembled in a particularly simple way. Moreover, rapid exchange of the at least one cuff unit can in particular also be permitted.

In principle, however, it would also be conceivable that the cuff unit is connected to the housing by means of an alternative connection that is deemed appropriate by a person skilled in the art. For example, it would be conceivable that, by way of the at least one fastening ring, the cuff unit is connected magnetically and releasably to the at least one housing. Simple assembly and rapid exchange of the at least one cuff unit could likewise be permitted in this way. In particular, a user-specific exchange of the cuff unit could in particular also be permitted reliably and quickly in this way. The cuff unit could in this case already be secured to a sleeve of an operator.

Furthermore, it is proposed that the at least one housing, at an opening area of the at least one blasting chamber, has a stiffening collar, which is provided on an upper edge of the base body and in which a receiving groove is integrated for receiving a seal. Preferably, the receiving groove is provided to receive a seal with form-fit engagement. Preferably, the seal is plugged into the receiving groove. Simple exchange of the seal could in particular be permitted in this way. Particularly preferably, the seal is provided to bear on a protective flap which, in at least one state, is provided to at least partially cover the opening area. In this context, an “opening area” of the blasting chamber is to be understood in particular as an area of maximum opening of the blasting chamber and/or of the housing. Preferably, it is to be understood in particular as an area of an insertion and removal opening of the blasting chamber and/or of the housing. Here, an “insertion and removal opening” is to be understood in particular as an opening through which products to be treated, in particular dental products, preferably before and/or after an operation, can be inserted into the blasting chamber and/or can be removed from the blasting chamber. Moreover, in this context, an “upper edge” is to be understood in particular as an edge with which the base body runs out toward the opening area and/or adjoins the opening area. Preferably, it is to be understood in particular as an edge which is arranged on a face of the base body directed away from a support base. Furthermore, in this context, a “stiffening collar” is to be understood in particular as a collar which serves to stiffen and stabilize the base body. Preferably, it is to be understood in particular as an at least partially peripheral, fold-like collar. Particularly preferably, it is to be understood in particular as a collar which has an at least approximately U-shaped cross section. In this context, a “seal” is to be understood in particular as an element which, in at least one operating state, is provided to at least limit unwanted transfer of material from one space into another. Preferably, at least in a closed state of the protective flap, the seal is provided to at least limit unwanted transfer of material from the blasting chamber to the environment in a gap between the base body and the protective flap. Various seals deemed appropriate by a person skilled in the art are conceivable, for example a profile seal.

With a suitable configuration of the blasting device, a high degree of stability and a high degree of stiffness of the housing can be reliably achieved. In particular, a wall thickness of the housing could thus be advantageously kept to a minimum. Moreover, the seal can thus be fastened in an advantageously simple way. Preferably, the assembly outlay can thus advantageously be kept to a minimum. In addition, simple exchange of the seal can also be permitted.

It is further proposed that the blasting device has a functional profile, which is connected fixedly to the at least one housing for the purpose of stabilizing the housing. Preferably, the functional profile also serves to securely fasten structural parts to the blasting device. In this context, a “functional profile” is to be understood in particular as a construction profile. Preferably, it is to be understood in particular as a construction profile which is provided to realize different functions. Particularly preferably, it is to be understood in particular as a construction profile on which at least several structural parts are fastened. In this way, an advantageously high degree of stability of the blasting device can be achieved. Moreover, at least some of the functions and fastening duties can be transferred from the housing to the functional profile. In this way, it is possible in turn to avoid a high degree of loading of the housing.

It is further proposed that the functional profile has at least one fastening groove for fastening at least one blasting material tank unit. Preferably, the fastening groove is formed by a T-shaped groove. In principle, however, it would also be conceivable to use other fastening grooves deemed appropriate by a person skilled in the art. By means of the fastening groove, a blasting material tank unit can be secured in a particularly reliable way. In particular, it would also be conceivable for various sizes of blasting material tank units to be able to be secured via the fastening groove.

It is also proposed that the functional profile is designed as an extruded profile. Preferably, the functional profile is designed as an aluminum extruded profile. In principle, however, it would also be conceivable for the functional profile to be designed as a plastic extruded profile. In this way, a high degree of stability of the functional profile can be achieved in particular. Moreover, a high degree of functionality of the functional profile can be achieved in this way. In addition, a functional profile can advantageously be produced in a cost-effective manner. It is furthermore proposed that the functional profile is made at least partially of an electrically conductive material. Preferably, the functional profile is made entirely of an electrically conductive material. Particularly preferably, the functional profile has at least one surface directly adjoining the blasting chamber. In this context, an “electrically conductive material” is to be understood in particular as a material or a material composite which, at a temperature of 25° C., has an electrical conductivity of at least 10⁻⁸ S/m, preferably at least 1 S/m, and particularly preferably at least 10⁵ S/m. It is thereby advantageously possible to obtain a discharge, in particular a static dissipation, of a static charge of the blasting device, in particular of the housing. If the functional profile is made of metal, it is in particular advantageously possible to obtain a discharge, in particular a static dissipation, of a static charge of the blasting device, in particular of the housing. If the functional profile is made of plastic, in particular of a plastic extruded profile, it is possible to obtain a static discharge, in particular a static dissipation, of a static charge of the blasting device, in particular of the housing, by using a conductive plastic.

In principle, however, it would also be conceivable for the functional profile to be injected onto the housing. In this way, it would be possible to achieve an advantageously high-density functionality. Moreover, an advantageously low production cost could be achieved in this way.

It is further proposed that the functional profile has at least one hinge groove for receiving a hinge profile of a protective flap which, in at least one operating state, is provided to cover an opening area of the at least one blasting chamber. Preferably, seen in cross section, the hinge groove is formed by an at least approximately circular groove, which is opened within a limited segment of a circle. In this context, a “hinge profile” is to be understood in particular as a preferably at least partially movable profile via which the protective flap can be moved, in particular pivoted, in a defined manner with respect to the functional profile. Preferably, it is to be understood in particular as a profile via which the protective flap can be folded open and folded shut in a defined manner. In this context, a “protective flap” is to be understood in particular as a flap and/or a lid by means of which the opening area can be at least partially covered, in particular during an operation. Preferably, the flap is provided at least to limit, preferably to prevent, an escape of abrasive material from the blasting chamber through the opening area during an operation. Particularly preferably, the flap is at least partially transparent and serves as a viewing window for an operator. During an operation, an operator is able to look through the protective flap into the blasting chamber. Here, the expression “transparent” is intended to define in particular a property of light transmittance of a material or of a structural part, wherein the material or the structural part in particular transmits at least more than 10%, preferably more than 50%, and particularly preferably more than 80%, of a spectral range of a visible light. Preferably, the spectral range of the visible light has a wavelength λ of approximately 350 nm to 800 nm. Particularly preferably, an object which, viewed along at least one direction, is covered completely by the transparent structural part is visible to an operator when looking along a direction that intersects the transparent structural part and the object. In this way, advantageously simple opening of the opening area can be permitted in particular. Moreover, expedient and reliable fastening of the protective flap can be achieved. In addition, rapid and simple assembly of the protective flap and of the hinge profile can be permitted. In particular, it is thus possible to omit screwing the hinge profile onto the functional profile.

It is further proposed that the hinge profile of the protective flap is at least partially elastic. Preferably, the hinge profile is made at least partially of an elastic material. Preferably, the hinge profile of the protective flap is made at least partially of an elastomer. Particularly preferably, the hinge profile has, on one side, a bead which is guided in the hinge groove of the functional profile. Preferably, the bead is mounted partially rotatably in the hinge groove. Particularly preferably, the hinge profile is formed in one piece. “At least partially elastic” is to be understood in particular as meaning that the hinge profile is repeatedly deformable at least in partial areas, without the partial area or the hinge profile being mechanically damaged or destroyed, and that the partial area or the hinge profile, in particular after a deformation, returns independently to its basic shape. Preferably, this is to be understood in particular as meaning that the hinge profile has, at least in partial areas, a modulus of elasticity of less than 10 GPa, preferably of less than 1 GPa, preferably less than 0.5 GPa, and particularly preferably less than 0.1 GPa. It is thus advantageously possible to dispense with a joint. Preferably, a mobility of the hinge profile can be obtained through a mobility of the material. Moreover, advantageously simple assembly can be achieved. Furthermore, a hinge with a large number of degrees of freedom can be obtained in this way. In particular, as a result of the at least partially elastic design of the hinge profile, height differences and/or tolerances can advantageously be compensated. Preferably, advantageous sealing of the protective flap can thus be achieved.

A corresponding design of the protective flap, in particular of the hinge profile, is in this case not limited in principle to a blasting device as per claim 1 and/or a functional profile as per claim 9. The use of a corresponding protective flap, in particular of a corresponding hinge profile, would also be conceivable in principle in an alternative blasting device, in particular a dental blasting device.

It is additionally proposed that the protective flap has at least one panel, and the hinge profile of the protective flap has at least one receiving area in which the panel is received by clamping. Preferably, the receiving area is designed as an edge protection profile. Particularly preferably, the receiving area is designed as an edge protection profile with a metal profile. Preferably, the receiving area is arranged on a face of the hinge profile directed away from the functional profile. In this context, a “panel” is to be understood in particular as a light-transmitting, in particular transparent panel, preferably a glass panel. Various glass panels that a person skilled in the art would deem appropriate are conceivable, for example plexiglass panels, acrylic glass panels and/or silicate glass panels. Moreover, in this context, “received by clamping” is to be understood in particular as meaning that the panel, in at least one direction, is held at least substantially with a force fit in the receiving area to prevent its falling out. Preferably, the panel is secured at least substantially with a force fit against falling out in a direction counter to the direction of insertion. Here, “at least substantially with a force fit” is to be understood in particular as meaning that at least 50%, preferably at least 70%, and particularly preferably at least 90%, of a holding force is applied with a force fit. Furthermore, in this context, an “edge protection profile” is to be understood in particular as a profile which is provided to be fitted onto a side edge of a panel. Preferably, it is to be understood in particular as a profile with an at least approximately U-shaped cross section. Preferably, it is to be understood in particular as a profile with a U-shaped skeleton band, which is preferably made at least partially of a metal, and with a jacket which encompasses the skeleton band and which is made at least partially of an elastomer. Advantageously simple assembly of the panel on the hinge profile can in particular be achieved in this way. Moreover, holes in the panel can be dispensed with. A simple exchange of the panel can additionally be permitted.

A corresponding design of the protective flap, in particular of the hinge profile, is in this case not limited in principle to a blasting device as per claim 1 and/or a functional profile as per claim 9. The use of a corresponding protective flap, in particular of a corresponding hinge profile, would also be conceivable in principle in an alternative blasting device, in particular a dental blasting device.

It is further proposed that the blasting device has at least one lighting unit, which is integrated at least partially in the functional profile. Preferably, the lighting unit is at least partially sealed off on the functional profile from the blasting chamber. Preferably, the functional profile serves as a cooling body of the lighting unit. Here, it would be conceivable in principle for additional cooling ribs to be formed integrally on the functional profile, in order to achieve a high cooling performance. Preferably, the functional profile additionally serves to at least partially accommodate an electrical system of the lighting unit. Here, a “lighting unit” is intended to be understood in particular as a unit which is provided at least to illuminate the blasting chamber. Particularly preferably, the lighting unit has at least one lighting element, which is designed as an LED. Moreover, in this context, “at least partially integrated” is to be understood in particular as meaning that at least parts of the lighting unit are at least partially arranged inside an external contour of the functional profile. An advantageous lighting unit can advantageously be made available in this way. Moreover, advantageously simple and rapid assembly can in particular be achieved. Preferably, the lighting unit can already be assembled together with the functional profile.

It is further proposed that the blasting device has at least one floor grill, which is arranged in the at least one blasting chamber and which has at least one integrated receiving quiver, which is provided to hold a handpiece in a parked position. Preferably, the handpiece is held in the receiving quiver in a defined parked position. Particularly preferably, the handpiece is held in the receiving quiver in an ergonomic parked position. Preferably, the receiving quiver has an integrated blast protector. Preferably, the floor grill is removable. Particularly preferably, the floor grill is arranged loosely in the blasting chamber. In principle, however, it would also be conceivable that the floor grill is formed integrally with the housing. It would in principle be conceivable for the floor grill to be injected onto the housing. It would also be conceivable for the floor grill to be pressed into the housing. In this context, an “ergonomic parked position” is to be understood in particular as a position of the handpiece into which the handpiece can be brought when it is not needed. Preferably, this is to be understood in particular as a position in which the handpiece is arranged in an area of the blasting chamber distinct from a work area and in which, in particular, a hose of the handpiece is also at least partially pressed into an area of the blasting chamber that is distinct from a work area. In this way, a high level of comfort during work can be achieved in particular. Moreover, the number of structural parts can be kept to a minimum.

The blasting device according to the invention here is not intended to be restricted to the embodiment and use described above. In particular it is possible for the blasting device according to the invention, for the purpose of performing a function described herein, to have a number of individual elements, structural parts and units which differs from a number thereof as indicated herein.

### DRAWINGS

Further advantages will become clear from the following description of the drawings, which show an illustrative embodiment of the invention. The drawings, description and claims contain numerous features in combination. A person skilled in the art will also expediently consider the features individually and combine them to form meaningful further combinations.

In the drawings:

FIG. 1 is a schematic and perspective view showing a blasting device with a blasting chamber, with a housing, with two blasting material tank units, and with a partially transparent protective flap,

FIG. 2 is an alternative schematic and perspective rear view showing the blasting device with the blasting chamber, with the housing, with the two blasting material tank units, and with the protective flap,

FIG. 3 is a schematic plan view showing the blasting device with the blasting chamber, with the housing, with the two blasting material tank units, and with the protective flap in an opened state,

FIG. 4 is an alternative schematic and perspective bottom view showing the blasting device with the blasting chamber, with the housing, with the two blasting material tank units, and with the protective flap, and

FIG. 5 is a schematic cross-sectional view showing the blasting device along the section line V-V.

### DESCRIPTION OF THE ILLUSTRATIVE EMBODIMENT

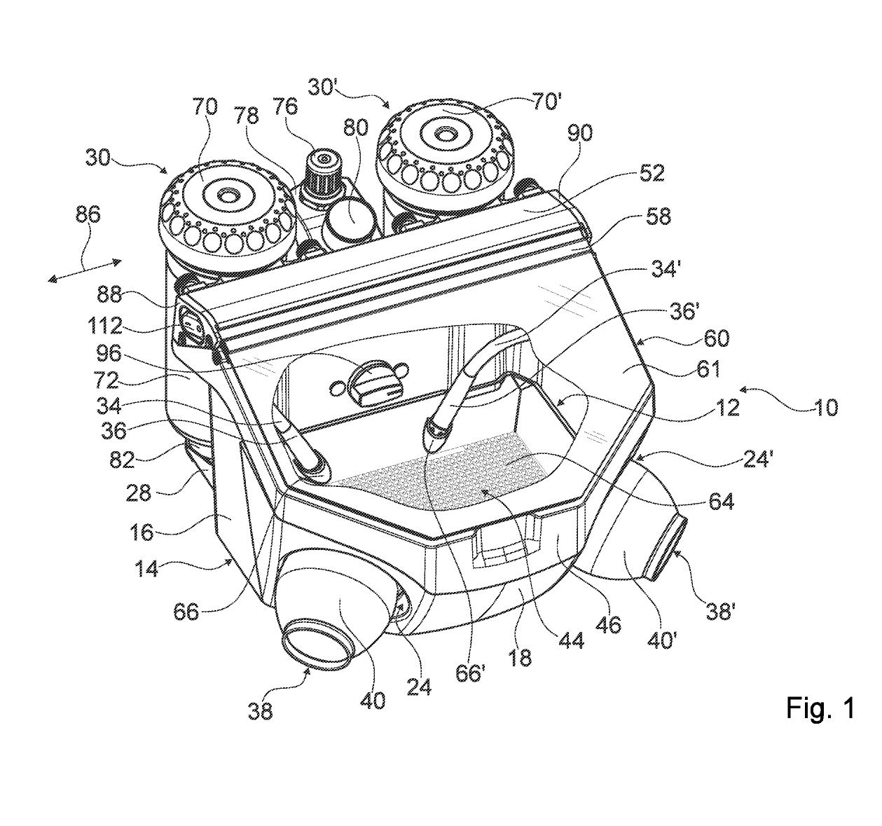

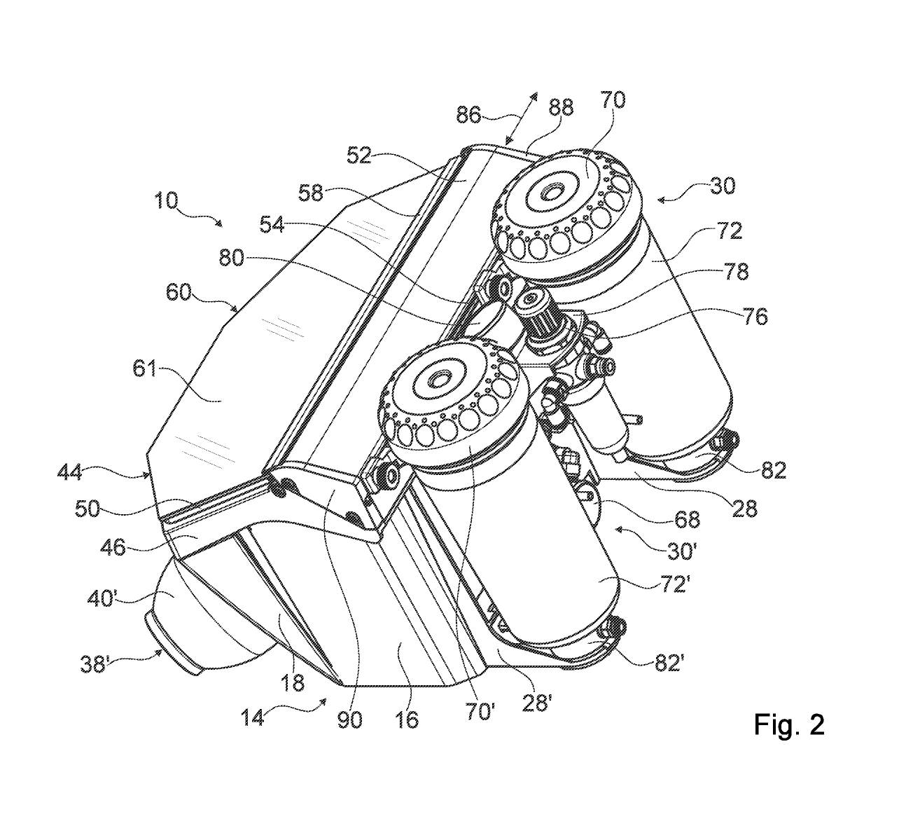

FIGS. 1 and 2 show a blasting device 10. The blasting device 10 is designed as a dental blasting device. The blasting device 10 is used to treat dental products. The blasting device 10 is provided to treat the dental products using abrasive material. The blasting device 10 operates according to a sandblasting principle in which the abrasive material is accelerated by compressed air and, upon impact with the dental product, removes material from the surface of said dental product.

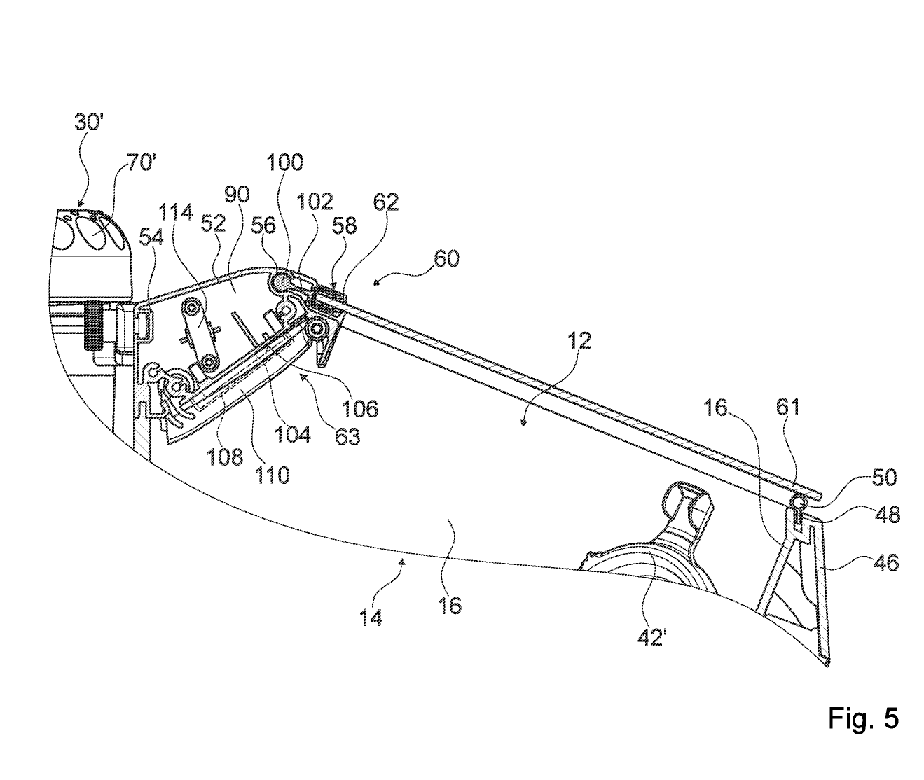

The blasting device 10 comprises a blasting chamber 12 and a housing 14. The housing 14 has a base body 16, which partially encompasses the blasting chamber 12. The base body 16 delimits the blasting chamber 12. The base body 16 is designed as a container which is open toward the top and which defines the blasting chamber 12. The blasting chamber 12 has a hexagonal contour. Moreover, the housing 14, at an opening area 44 of the blasting chamber 12, has a stiffening collar 46 on an upper edge of the base body 16. The stiffening collar 46 forms a part of the base body 16. The stiffening collar 46 serves to stiffen and stabilize the base body 16. Moreover, the stiffening collar 46 is formed by a peripheral fold-like collar with an approximately U-shaped cross section. The opening area 44 forms an area of an insertion and removal opening of the blasting chamber 12, through which products to be treated, in particular dental products, can be inserted into the blasting chamber 12 before an operation and can be removed from the blasting chamber 12 after an operation. The housing 14 of the blasting device 10 is made of plastic. The housing 14 is made of an ABS plastic. The housing 14 is produced at least partially in an injection molding method. The housing 14 is produced completely in an injection molding method. The housing 14 is produced in a thermoplastic injection molding method (FIGS. 1 and 5).

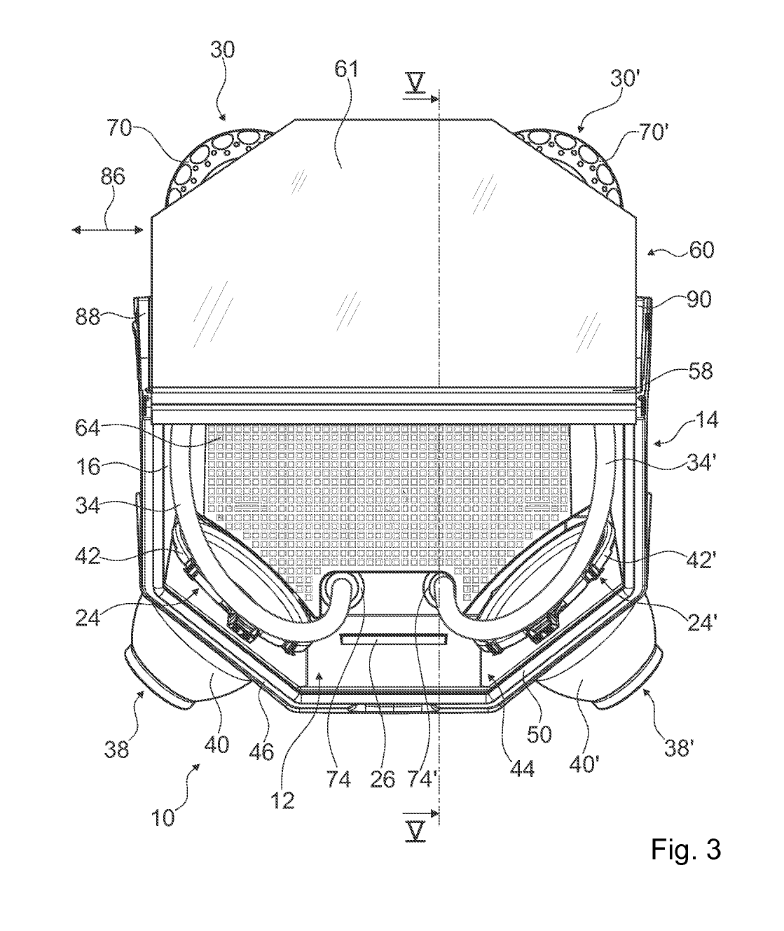

The housing 14 has two hand ports 24, 24′ through which an operator can access the blasting chamber 12 during an operation. The hand ports 24, 24′ are introduced into the base body 16. The hand ports 24, 24′ are each arranged on a front face of the base body 16 directed toward an operator. The blasting device 10 has two cuff units 38, 38′. The cuff units 38, 38′ are each arranged in one of the hand ports 24, 24′, respectively. The cuff units 38, 38′ are provided to prevent unwanted escape of abrasive material from the hand ports 24, 24′. The cuff units 38, 38′ each have a cuff 40, 40′. The cuffs 40, 40′ are each formed by a tubular element of material which, on a free side, has an elastic band. The cuffs 40, 40′ are provided to lie on the arms of an operator during an operation. However, it would also be conceivable in principle for the cuff 40, 40′ to be designed in another way that appears appropriate to a person skilled in the art. Moreover, the cuff units 38, 38′ each have a fastening ring 42, 42′. The fastening rings 42, 42′ are provided to fasten the associated cuffs 40, 40′ in the hand ports 24, 24′. The cuff units 38, 38′ are connected releasably to the housing 14 via the fastening rings 42, 42′, in each case in the manner of a bayonet catch. The cuff units 38, 38′ are connected releasably to the base body 16 of the housing 14 via the fastening rings 42, 42′, in each case in the manner of a bayonet catch. The fastening rings 42, 42′ can for this purpose be fastened in fastening recesses (not shown) that are arranged around the hand ports 24, 24′ in the base body 16 of the housing 14 (FIG. 3).

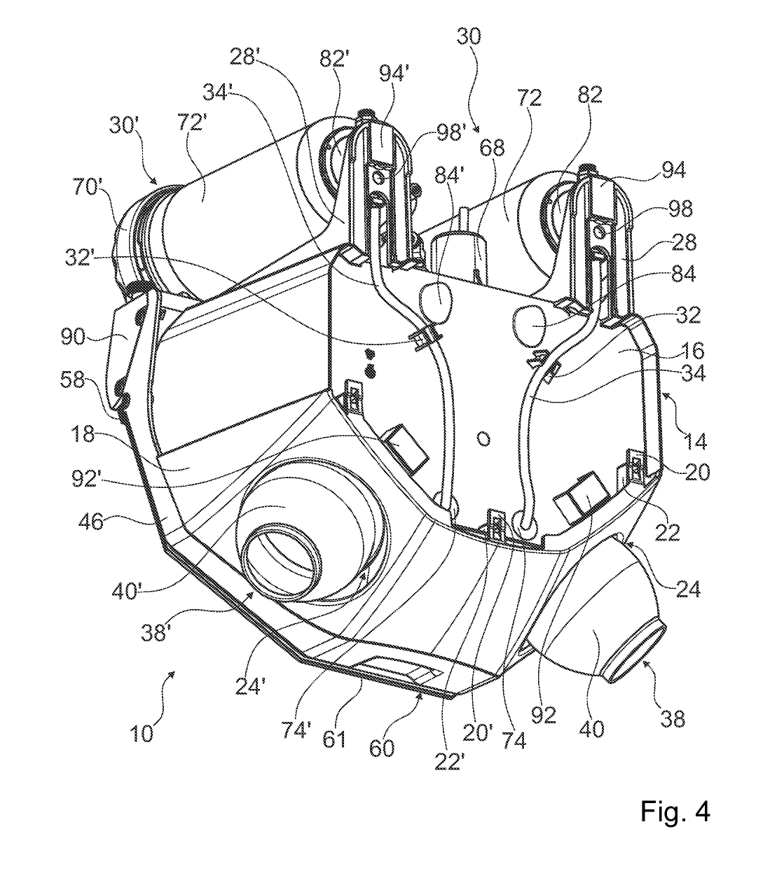

Moreover, the blasting device 10 has a front apron 18. The front apron 18 is connected fixedly to the housing 14. Moreover, the front apron 18 is provided to cover a partial area of the housing 14. The front apron 18 is provided to cover a partial area of the base body 16 of the housing 14. In an assembled state, the front apron 18 covers a front face of the base body 16 directed toward an operator. In an area of the hand ports 24, 24′ of the housing 14, the front apron 18 has apertures that correspond to the hand ports 24, 24′. The front apron 18 bears directly on the hand ports 24, 24′. The front apron 18 is made of plastic. The front apron 18 is made of an ABS plastic. In an assembled state of the front apron 18, the front apron 18 is spaced apart from the base body 16 along a substantial extent. An air cushion is located between the front apron 18 and the base body 16. Soundproofing can advantageously be achieved in this way. The front apron 18 is latched onto the housing 14 from the outside. The front apron 18 has three latching elements 20, 20′, 20″, which latch onto a respectively corresponding latching element 22, 22′, 22″ of the housing 14. The latching elements 20, 20′, 20″ of the front apron 18 are arranged on a bottom edge of the front apron 18. The corresponding latching elements 22, 22′, 22″ of the housing 14 are arranged on an underside of the base body 16. In principle, however, it would also be conceivable to have a different number and/or arrangement of the latching elements 20, 20′, 20″, 22, 22′, 22″ if deemed appropriate by a person skilled in the art (FIG. 4).

Furthermore, the housing 14 has a ventilation opening 26 distinct from the hand ports 24, 24′. The ventilation opening 26 is introduced into the base body 16. The ventilation opening 26 is arranged, between the hand ports 24, 24′, on a front face of the base body 16 directed toward an operator. Air can pass through the ventilation opening 26 into the blasting chamber 12 in a controlled manner. Air is sucked into the blasting chamber 12 via the ventilation opening 26. Moreover, on a rear face of the base body 16, the housing 14 has a suction opening 68 through which air and abrasive material can be sucked out of the blasting chamber 12. During operation, a further suction piece (not shown) is preferably attached to the suction opening 68. The housing 14 has the suction opening 68, which is at least partially integral with the base body 16 of the housing 14. The suction opening 68 has a guide tube. The guide tube of the suction opening 68 delimits the actual opening area of the suction opening 68. The guide tube is injection molded onto the base body 16 of the housing 14. Accordingly, in order to avoid an underpressure, the same amount of air can be sucked through the ventilation opening 26 into the blasting chamber 12 as is sucked out through the suction opening 68. In an assembled state of the front apron 18, the ventilation opening 26 is covered by the front apron 18. Seen from the outside, the ventilation opening 26 is covered from view by the front apron 18. The ventilation opening 26 is spaced apart from the front apron 18 (FIGS. 3 and 5).

The housing 14 moreover has two jib units 28, 28′ formed integrally with the base body 16 of the housing 14. The jib units 28, 28′ are injection molded onto the base body 16. The jib units 28, 28′ are arranged on a face of the base body 16 lying opposite the front apron 18. The jib units 28, 28′ protrude approximately perpendicularly like stages from the base body 16. Moreover, the jib units 28, 28′ are provided as a bottom receptacle of respective blasting material tank units 30, 30′. The two blasting material tank units 30, 30′ bear on the two jib units 28, 28′. The jib units 28, 28′ each have a groove via which the blasting material tank units 30, 30′ are positioned on the jib units 28, 28′. Moreover, the jib units 28, 28′ of the housing 14 each have a recess 98, 98′. The recesses 98, 98′ are each provided to laterally secure the associated blasting material tank unit 30, 30′. The recesses 98, 98′ are each provided to laterally secure the associated blasting material tank unit 30, 30′ by receiving an extension piece (not shown) of the associated blasting material tank unit 30, 30′. The recesses 98, 98′ each receive an extension piece of a mixing unit 82, 82′ of the associated blasting material tank unit 30, 30′. Moreover, the jib units 28, 28′ also serve to support the base body 16. In this way, it is possible to obtain a high degree of stability and protection against tilting (FIG. 2).

The two blasting material tank units 30, 30′ are arranged on a face of the base body 16 lying opposite the front apron 18. The blasting material tank units 30, 30′ are connected releasably to a housing 14 of the blasting device 10. Both blasting material tank units 30, 30′ each comprise a tank lid 70, 70′ and a tank container 72, 72′. The tank containers 72, 72′ are provided to hold abrasive material. Each of the blasting material tank units 30, 30′ is connected to a handpiece 36, 36′ by means of a hose 34, 34′. The handpieces 36, 36′ each have a nozzle on a front end directed away from the hose 34, 34′. Abrasive material, located in the corresponding blasting material tank units 30, 30′, is guided as a mixture of abrasive material and air through the hoses 34, 34′ to the handpiece 36, 36′ and into the blasting chamber 12. By way of the nozzles on the handpieces 36, 36′, the mixture of abrasive material and air emerges in each case as a focused jet from the particular handpiece 36, 36′ in use. The hoses 34, 34′ are for this purpose guided on an underside of the base body 16 of the housing 14 and are each guided into the blasting chamber 12 through a hose opening 74, 74′ in a bottom of the base body 16. Rubber bushings are arranged in each of the hose openings 74, 74′ and are intended to prevent abrasive material from falling out of the blasting chamber 12. The blasting material tank units 30, 30′ are at an overpressure during an operation. This overpressure can be varied and adjusted by an operator via an adjustment unit 76. The adjustment unit 76 is formed by a pressure reducer. By adjusting the overpressure in the blasting material tank units 30, 30′, it is possible to adjust the blasting power of the mixture of abrasive material and air emerging from a nozzle of one of the handpieces 36, 36′.

The adjustment unit 76 is arranged on a further jib unit 78. The housing 14 has the further jib unit 78. The jib unit 78 is formed integrally with the base body 16 of the housing 14. The jib unit 78 is injection molded onto the base body 16. The jib unit 78 is arranged on a face of the base body 16 lying opposite the front apron 18. The jib unit 78 protrudes approximately perpendicularly like a stage from the base body 16. The jib unit 78 is arranged between the two blasting material tank units 30, 30′. The jib unit 78 is provided to receive the adjustment unit 76 for adjusting a pressure of the blasting material tank units 30, 30′. Moreover, a pressure sensor unit 80 for reading off and monitoring an adjusted overpressure in the tank containers 72, 72′ of the blasting material tank units 30, 30′ is arranged on the jib unit 78. The tank containers 72, 72′ of the blasting material tank units 30, 30′ each have an interior for holding the abrasive material. Moreover, the interior of each of the blasting material tank units 30, 30′ holds air which, during an operation, is at an overpressure in relation to an environment of the blasting material tank units 30, 30′. The pressure sensor unit 80 senses the value of the overpressure and forwards this value to an operator via an output unit (FIGS. 2 and 4).

Moreover, the blasting material tank units 30, 30′ each have two attachment elements. The blasting material tank units 30, 30′ each have a first attachment element and a second attachment element. The first attachment elements each form a compressed-air inlet of the associated blasting material tank unit 30, 30′. The first attachment elements are provided for attachment to an internal compressed-air delivery system (not shown in detail) of the dental blasting device. The second attachment elements each form an attachment for the hose 34, 34′ of the associated handpiece 36, 36′. The second attachment elements thus each form an outlet for the mixture of air and abrasive material. The blasting material tank units 30, 30′ each have a mixing unit 82, 82′ with which the compressed air introduced into the blasting material tank units 30, 30′ via the first attachment elements is mixed with the abrasive material stored in the interior of the blasting material tank units 30, 30′. The mixing units 82, 82′ are arranged in a bottom area of the blasting material tank units 30, 30′ and form a bottom of the tank containers 72, 72′. The mixing units 82, 82′ and the tank containers 72, 72′ are connected to each other via a screw connection and can be released from each other without damage (FIGS. 2 and 4).

During an operation, only one of the blasting material tank units 30, 30′ can be used at a time. To be able to switch between the blasting material tank units 30, 30′ and thus between the handpieces 36, 36′, a switch 96 is arranged in the blasting chamber 12, on a rear wall of the base body 16 of the housing 14 directed away from the front apron 18, making it possible to switch between the blasting material tank units 30, 30′ and between the handpieces 36, 36′, respectively. The blasting material tank units 30, 30′ can each be filled with different abrasive material (FIG. 1).

Furthermore, the housing 14 has two hose retainers 32, 32′ formed integrally with the base body 16 of the housing 14. The hose retainers 32, 32′ are injection molded onto the base body 16, on an underside of the base body 16. The hose retainers 32, 32′ are each formed by two-armed clips, which are provided to partially engage around a hose 34, 34′. The hose retainers 32, 32′ are provided to guide the hoses 34, 34′ of the handpieces 36, 36′ on an underside of the housing 14. The hose retainers 32, 32′ are provided to position the hoses 34, 34′ of the handpieces 36, 36′ on an underside of the housing 14. Each of the two hoses 34, 34′ of the handpieces 36, 36′ is to be clamped releasably in one of the hose retainers 32, 32′, respectively. In principle, however, it is also conceivable to have a different number and/or arrangement of the hose retainers 32, 32′ if deemed appropriate by a person skilled in the art (FIG. 4).

Moreover, the blasting device 10 has a floor grill 64 arranged in the blasting chamber 12. The floor grill 64 is laid loosely on a bottom of the blasting chamber 12. The floor grill 64 is made of plastic. In a central area, the floor grill 64 has a grill structure through which abrasive material can fall onto the bottom of the blasting chamber 12. On the bottom of the blasting chamber 12, the abrasive material is preferably sucked out via the suction opening 68. The floor grill 64 has two integrated receiving quivers 66, 66′. The receiving quivers 66, 66′ of the floor grill 64 are arranged in a rear area of the blasting chamber 12 directed away from the hand ports 24, 24′, in an edge area of the floor grill 64. The receiving quivers 66, 66′ are provided to each hold a handpiece 36, 36′ of the blasting device 10 in a parked position. The receiving quivers 66, 66′ are provided to hold the handpieces 36, 36′ of the blasting device 10 in a defined, ergonomic parked position. In the ergonomic parked position, the handpieces 36, 36′ are arranged in an area of the blasting chamber 12 distinct from a work area. Moreover, in the ergonomic parked position, a hose 34, 34′ of the respective handpiece 36, 36′ is pressed into an area of the blasting chamber 12 that is distinct from a work area. In the ergonomic parked position, the handpieces 36, 36′ are arranged in a rear area of the blasting chamber 12 directed away from the hand ports 24, 24′. The handpieces 36, 36′ are arranged next to each other in the parked position, as seen from a front face of the blasting device 10. Moreover, in the parked position, the rear ends of the handpieces 36, 36′, by which ends the handpieces 36, 36′ are connected to the respectively associated hose 34, 34′, slope away from each other in the direction of the respectively closer side wall. In this way, a hose 34, 34′ of the respective handpiece 36, 36′ can advantageously be guided on an edge of the blasting chamber 12. Moreover, the bottom of the base body 16 has two depressions 84, 84′ into which one of the handpieces 36, 36′, respectively, protrudes in a parked position. In this way, the handpieces 36, 36′ can be positioned as deep as possible. The depressions 84, 84′ are arranged below the receiving quivers 66, 66′. Moreover, the receiving quivers 66, 66′ each have a blast protector (not shown). The blast protector is in each case arranged in an end of the receiving quivers 66, 66′ directed away from a receiving opening. The blast protector is provided for the purpose of preventing destruction of the receiving quivers 66, 66′ or of the bottom of the base body 16 by abrasive material that emerges from the handpieces 36, 36′ when an operator places a handpiece 36, 36′ into the receiving quiver 66, 66′ without deactivating a jet of abrasive material. In principle, it would also be conceivable for each of the depressions 84, 84′ to be used as a blast protector, in which case the parked position of the handpiece 36, 36′ causes abrasive material to enter tangentially into the depression 84, 84′ and thus be deflected (FIGS. 1 and 3).

Furthermore, the blasting device 10 has a functional profile 52. The functional profile 52 is connected fixedly to the at least one housing 14 in order to stabilize the housing 14. Moreover, the functional profile 52 serves for the secure fastening of structural parts. The functional profile 52 is arranged on the top edge of the base body 16. The functional profile 52 is arranged on the stiffening collar 46, on a face of the base body 16 directed away from the front apron 18. The functional profile 52 is screwed onto the housing 14. Moreover, the functional profile 52 is designed as an extruded profile. The functional profile 52 is designed as an aluminum extruded profile. In principle, however, it would also be conceivable for the functional profile 52 to be designed as a plastic extruded profile. The functional profile 52 has a constant cross section along a main direction of extent 86. At both of its ends, the functional profile 52 is covered by a respective cover 88, 90. The covers 88, 90 are each screwed onto the functional profile 52. Moreover, the covers 88, 90 each close off the ends of the functional profile 52. The functional profile 52 moreover has a fastening groove 54. The fastening groove 54 is formed by a T-shaped groove. In principle, however, it would also be conceivable to use other fastening grooves 54 deemed appropriate by a person skilled in the art. The fastening groove 54 extends along the main direction of extent 86 of the functional profile 52, over a full extent of the functional profile 52. The fastening groove 54 is arranged on a face of the functional profile 52 directed way from the front apron 18. The fastening groove 54 is open toward a rear face. The fastening groove 54 serves to fasten the blasting material tank units 30, 30′. The blasting material tank units 30, 30′ are each fastened to the fastening groove 54 by two screws, which are screwed into square nuts in the fastening groove 54. In this way, the blasting material tank units 30, 30′ can be oriented advantageously. Preferably, the blasting material tank units 30, 30′ can thus be oriented advantageously with respect to the jib units 28, 28′ (FIGS. 2 and 5).

Moreover, the functional profile 52 has a hinge groove 56. The hinge groove 56 extends along the main direction of extent 86 of the functional profile 52, over a full extent of the functional profile 52. The hinge groove 56 is arranged on a face of the functional profile 52 directed toward the front apron 18. Seen in cross section, the hinge groove 56 is formed by an at least approximately circular groove, which is opened within a limited segment of a circle. The hinge groove 56 is open toward a front face. The hinge groove 56 is provided to receive a hinge profile 58 of a protective flap 60. The protective flap 60 is provided to cover the opening area 44 of the blasting chamber 12 in one operating state. During operation, the protective flap 60 is provided to cover the opening area 44 of the blasting chamber 12. The protective flap 60 can be opened or closed manually by a user. During operation, the protective flap 60 is intended to prevent escape of abrasive material from the insertion and removal opening of the blasting chamber 12. The hinge profile 58 of the protective flap 60 is partially elastic. The hinge profile 58 of the protective flap 60 is made partially of an elastomer. The hinge profile 58 of the protective flap 60 is designed partially as a rubber strip. The hinge profile 58 extends along the main direction of extent 86 of the functional profile 52, over a full extent of the functional profile 52. The hinge profile 58 has a constant cross section along the main direction of extent 86. On one face, the hinge profile 58 has a bead 100, which is guided in the hinge groove 56 of the functional profile 52. The bead 100 extends over a full main extent of the hinge profile 58. To insert the hinge profile 58 into the hinge groove 56, one of the covers 88, 90 has to be removed. Moreover, the protective flap 60 has a panel 61. The hinge profile 58 has a receiving area 62, in which the panel 61 is received by clamping. The panel 61 is held in the receiving area 62 with a force fit. The receiving area 62 is designed as an edge protection profile. The receiving area 62 is composed of a U-shaped skeleton band, with a casing of elastomer encompassing the skeleton band. The receiving area 62 extends over a full direction of extent of the hinge profile 58. Seen in a cross section of the hinge profile 58, the receiving area 62 is arranged on a face of the hinge profile 58 lying opposite the bead 100. An elastic web 102 is arranged between the receiving area 62 and the bead 100. The hinge profile 58 is formed substantially in one piece. The panel 61 serves to cover the opening area 44 of the blasting chamber 12. The panel 61 has a size approximately corresponding to a size of the opening area 44. The panel 61 is transparent. In FIG. 1 the transparency of the panel 61 has been indicated by a partial area of the panel 61 being cut out. In a closed state of the protective flap 60, it is possible to look through the panel 61 into the blasting chamber 12. The protective flap 60 can be opened and closed through elasticity of the hinge profile 58 (FIGS. 1, 3 and 5).

A receiving groove 48 for receiving a seal 50 is integrated in the stiffening collar 46. The receiving groove 48 is provided to receive the seal 50 with form-fit engagement. The seal 50 is inserted into the receiving groove 48. The seal 50 extends along a front area of the stiffening collar 46, from one end of the functional profile 52 to another. The seal 50 is provided to bear on the panel 61 in a closed state of the protective flap 60 (FIGS. 3 and 5).

Moreover, the blasting device 10 has a lighting unit 63. The lighting unit 63 is provided to illuminate the blasting chamber 12. The lighting unit 63 is partially integrated in the functional profile 52. The lighting unit 63 has an LED module 104. The LED module 104 is arranged on an inner face 106 of the functional profile 52 directed toward the blasting chamber 12. The LED module 104 is fixedly connected to the functional profile 52. The functional profile 52 also serves here as a cooling body. Moreover, the lighting unit 63 has a first transparent cover 108, which covers the LED module 104. The first transparent cover 108 engages over the LED module 104 and is screwed onto the functional profile 52 on the inner face 106. Moreover, the first transparent cover 108 has an O-ring (not shown) which bears on the inner face 106 of the functional profile 52. By means of the O-ring, the LED module 104 on the functional profile 52 is sealed off from the blasting chamber 12. Entry of abrasive material can be prevented in this way. Furthermore, the lighting unit 63 has a second transparent cover 110. The second transparent cover 110 is formed by a cascaded covering. The second transparent cover 110 is arranged over the first cover 108. Moreover, the second transparent cover 110 is latched onto the functional profile 52. The second cover 110 is designed as an exchangeable cover. In this way, the second transparent cover 110 can be easily replaced if tarnished. Moreover, tarnishing of the first transparent cover 108 can be prevented in this way. Moreover, the lighting unit 63 has an electrical system, which is integrated in the functional profile 52. The lighting unit 63 has an operating switch 112. The operating switch 112 is integrated in a first cover 88 of the functional profile 52. Moreover, the lighting unit 63 has a strain relief element 114. The strain relief element 114 is provided such that a possible force acting on a mains cable can be led off to the housing 14 or the functional profile 52. The strain relief element 114 is arranged on an inner face of a second cover 90 of the functional profile 52 (FIG. 5).

Furthermore, the housing 14 has four feet 92, 92′, 94, 94′. Two of the feet 92, 92′ are formed integrally with the base body 16. The two feet 92, 92′ are injection molded on an underside of the base body 16. The two other feet 94, 94′ are formed integrally with one of the jib units 28, 28′, respectively. The two other feet 94, 94′ are injection molded on an underside of the jib units 28, 28′. Moreover, a layer that prevents slipping is affixed to each of the feet 94, 94′. A foam is affixed to each of the feet 94, 94′ (FIG. 4).

1. A blasting device, in particular a dental blasting device, with at least one blasting chamber, and with at least one housing, which is made at least partially of plastic and has at least one base body at least partially encompassing the blasting chamber, wherein the housing is produced at least partially in an injection molding method.

2. The blasting device as claimed in claim 1, comprising at least one front apron, which is fixedly connected to the housing and is provided to cover at least a partial area of the housing.

3. The blasting device as claimed in claim 2, wherein the at least one front apron has at least one latching element, which latches with at least one corresponding latching element of the housing.

4. The blasting device as claimed in claim 2, wherein the at least one housing has at least one ventilation opening, which is distinct from a hand port and which, in an assembled state of the front apron, is covered at least substantially by the front apron.

5. The blasting device as claimed in claim 1, wherein the at least one housing has at least one jib unit, which is formed integrally with the base body of the housing- and which is provided as a bottom support for at least one blasting material tank unit.

6. The blasting device as claimed in claim 1, wherein the at least one housing has at least one hose retainer, which is formed integrally with the base body of the housing and which is provided to guide a hose of a handpiece on an underside of the housing.

7. The blasting device as claimed in claim 1, comprising at least one cuff unit with at least one cuff and with at least one fastening ring, by means of which the cuff unit is connected releasably, in the manner of a bayonet catch, to the at least one housing.

8. The blasting device as claimed in claim 1, wherein the at least one housing, at an opening area of the at least one blasting chamber, has a stiffening collar, which is provided on an upper edge of the base body and in which a receiving groove is integrated for receiving a seal.

9. The blasting device as claimed in claim 1, comprising a functional profile, which is connected fixedly to the at least one housing for the purpose of stabilizing the housing.

10. The blasting device as claimed in claim 9, wherein the functional profile has at least one fastening groove for fastening at least one blasting material tank unit.

11. The blasting device as claimed in claim 9, wherein the functional profile is designed as an extruded profile.

12. The blasting device as claimed in claim 9, wherein the functional profile is made at least partially of an electrically conductive material.

13. The blasting device as claimed in claim 9, wherein the functional profile has at least one hinge groove for receiving a hinge profile of a protective flap which, in at least one operating state, is provided to cover an opening area of the at least one blasting chamber.

14. The blasting device as claimed in claim 13, wherein the hinge profile of the protective flap is at least partially elastic.

15. The blasting device as claimed in claim 13, wherein the protective flap has at least one panel, and the hinge profile of the protective flap has at least one receiving area, in which the panel is received by clamping.

16. The blasting device as claimed in claim 9, comprising at least one lighting unit, which is integrated at least partially in the functional profile.

17. The blasting device as claimed in claim 1, comprising at least one floor grill, which is arranged in the at least one blasting chamber and which has at least one integrated receiving quiver, which is provided to hold a handpiece in a parked position.

18. The blasting device as claimed in claim 3, wherein the at least one housing has at least one ventilation opening, which is distinct from a hand port and which, in an assembled state of the front apron, is covered at least substantially by the front apron.

19. The blasting device as claimed in claim 2, wherein the at least one housing has at least one jib unit, which is formed integrally with the base body of the housing and which is provided as a bottom support for at least one blasting material tank unit.

20. The blasting device as claimed in claim 2, wherein the at least one housing has at least one hose retainer, which is formed integrally with the base body of the housing and which is provided to guide a hose of a handpiece on an underside of the housing.
